(19) United States
(12) Patent Application Publication
(10) Pub. No.: US 2005/0270760 A1
(43) Pub. Date: Dec. 8, 2005

(54) Keyboard having a light emitting effect

(75) Inventor: Teng-Shun Hung, Tai-Bao City (TW)

Correspondence Address: NIKOLAI & MERSEREAU, P.A., 900 SECOND AVENUE SOUTH, SUITE 820, MINNEAPOLIS, MN, 55402, US

(73) Assignee: Horng Technical Enterprise Co., Ltd., Tai-Bao City (TW)

(21) Appl. No.: 10/862,747

(22) Filed: Jun. 7, 2004

(51) Int. Cl. G01D 11/28

(52) U.S. Cl. 362/23

(57) ABSTRACT

A keyboard includes a main body formed with a receiving recess, a transparent panel mounted on the main body and having formed with a plurality of openings, and a lamp seat mounted in the receiving recess and provided with a plurality of indication lamps each partially inserted into a respective one of the openings. Thus, the corners of each of the openings have different angles, so that the light beams emitted from each of the indication lamps have different angles by refraction of the corners of the respective opening of the transparent panel to produce a diffusion effect of different angles on the transparent panel, thereby enhancing the aesthetic quality of the keyboard.

### BACKGROUND OF THE INVENTION

1. Field of the Invention

The present invention relates to a keyboard, and more particularly to a keyboard having a light emitting effect.

2. Description of the Related Art

A keyboard is usually used to input information into a computer so that a user can operate the computer conveniently. However, the conventional keyboard lacks variation in its shape and outer appearance, thereby decreasing the versatility of the conventional keyboard.

### SUMMARY OF THE INVENTION

In accordance with the present invention, there is provided a keyboard, comprising:
a main body having a side formed with a receiving recess;
a transparent panel mounted on the main body and having a side formed with a plurality of openings; and
a lamp seat mounted in the receiving recess of the main body and provided with a plurality of indication lamps each aligned with and partially inserted into a respective one of the openings of the transparent panel.

The primary objective of the present invention is to provide a keyboard having a light emitting effect.

Another objective of the present invention is to provide a keyboard, wherein the corners of each of the openings of the transparent panel have different angles, so that the light beams emitted from each of the indication lamps have different angles by refraction of the corners of the respective opening of the transparent panel so as to produce a diffusion effect of different angles on the transparent panel, thereby enhancing the aesthetic quality of the keyboard.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a keyboard in accordance with the preferred embodiment of the present invention;

FIG. 2 is an exploded perspective view of the keyboard as shown in FIG. 1;

FIG. 3 is a partially enlarged view of the keyboard as shown in FIG. 2;

FIG. 4 is a partially enlarged view of the keyboard as shown in FIG. 2;

FIG. 5 is a partially enlarged view of the keyboard as shown in FIG. 2; and

FIG. 6 is a top plan view of the keyboard as shown in FIG. 5.

### DETAILED DESCRIPTION OF THE INVENTION

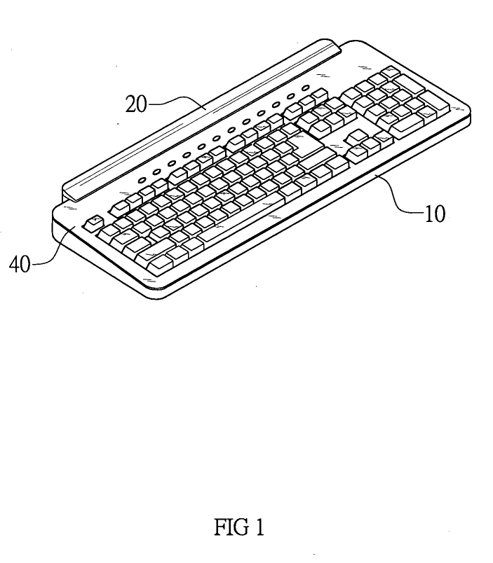

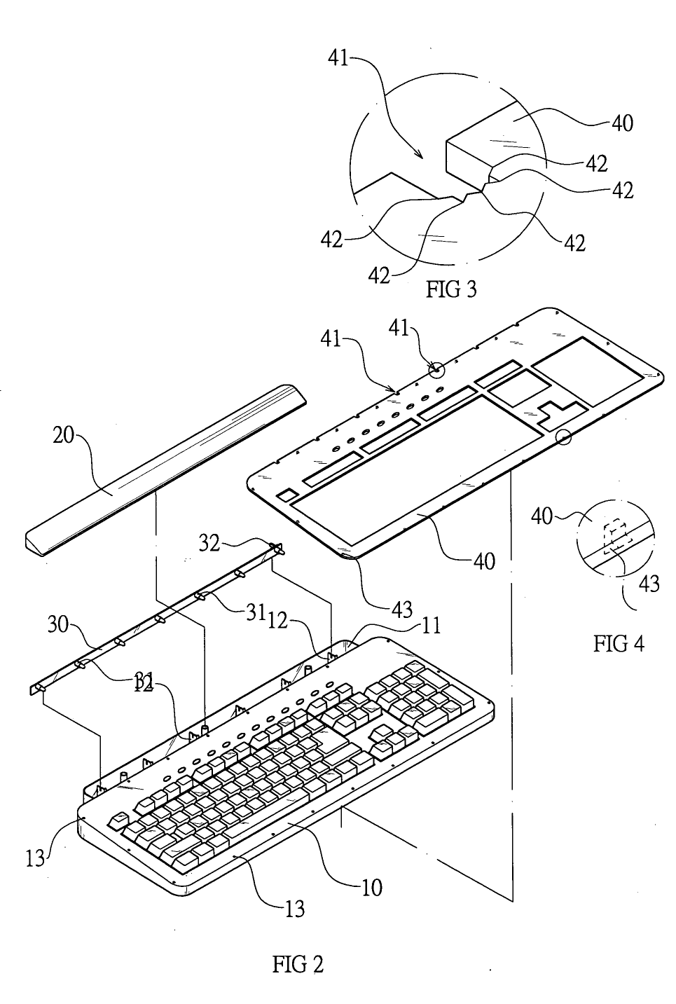

Referring to the drawings and initially to FIGS. 1-5, a keyboard in accordance with the preferred embodiment of the present invention comprises a main body 10 having a side formed with a receiving recess 11, a transparent panel 40 mounted on the main body 10 and having a side formed with a plurality of openings 41, a lamp seat 30 mounted in the receiving recess 11 of the main body 10 and provided with a plurality of indication lamps 31 each aligned with and partially inserted into a respective one of the openings 41 of the transparent panel 40, and a cover 20 mounted on the main body 10 to cover the lamp seat 30 mounted in the receiving recess 11 of the main body 10.

The receiving recess 11 of the main body 10 is provided with a plurality of locking plates 12 for insertion of the lamp seat 30. The main body 10 has a periphery formed with a plurality of locking holes 13.

Each of the openings 41 of the transparent panel 40 has an inside formed with a plurality of corners 42 (see FIG. 3) having different angles, so that when each of the indication lamps 31 emit light beams in the respective opening 41 of the transparent panel 40, the light beams emitted from each of the indication lamps 31 have different angles by refraction of the corners 42 of the respective opening 41 of the transparent panel 40.

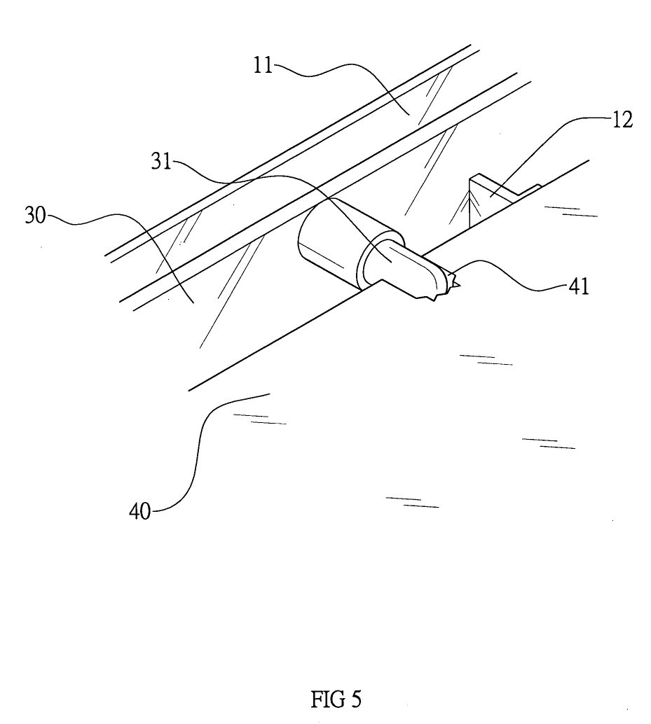

The transparent panel 40 has a periphery formed with a plurality of locking bosses 43 (see FIG. 4) each snapped into and detachably locked in a respective one of the locking holes 13 of the main body 10.

The lamp seat 30 is provided with a switch 32 to control operation of the indication lamps 31.

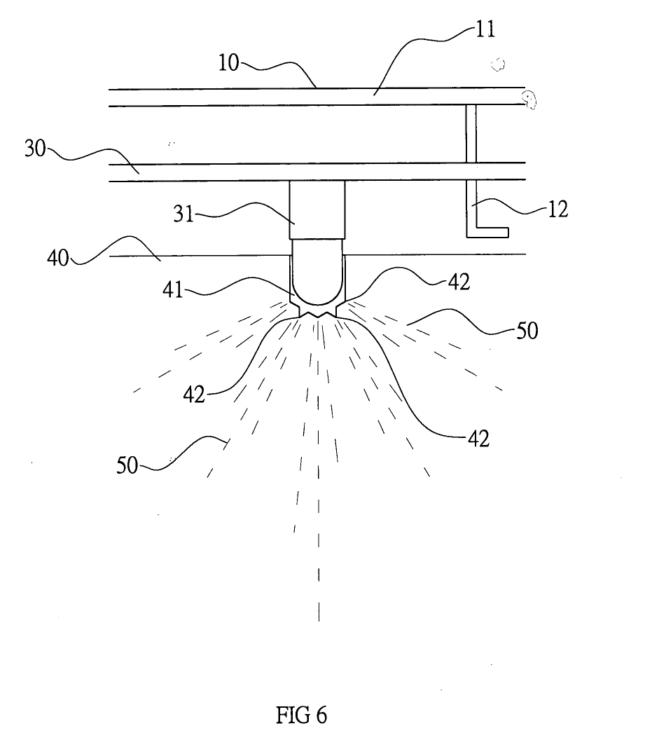

In operation, referring to FIG. 6 with reference to FIGS. 1-5, when the main body 10 is connected to the computer, the power of the computer is supplied into the main body 10, so that each of the indication lamps 31 emit light beams 50 in the respective opening 41 of the transparent panel 40. At this time, the corners 42 of each of the openings 41 of the transparent panel 40 have different angles, so that the light beams 50 emitted from each of the indication lamps 31 have different angles by refraction of the corners 42 of the respective opening 41 of the transparent panel 40 so as to produce a diffusion effect of different angles on the transparent panel 40, thereby enhancing the aesthetic quality of the keyboard.

Accordingly, the corners of each of the openings of the transparent panel have different angles, so that the light beams emitted from each of the indication lamps have different angles by refraction of the corners of the respective opening of the transparent panel so as to produce a diffusion effect of different angles on the transparent panel, thereby enhancing the aesthetic quality of the keyboard.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A keyboard, comprising:
a main body having a side formed with a receiving recess;
a transparent panel mounted on the main body and having a side formed with a plurality of openings; and
a lamp seat mounted in the receiving recess of the main body and provided with a plurality of indication lamps each aligned with and partially inserted into a respective one of the openings of the transparent panel.

2. The keyboard in accordance with claim 1, further comprising a cover mounted on the main body to cover the lamp seat mounted in the receiving recess of the main body.

3. The keyboard in accordance with claim 1, wherein the receiving recess of the main body is provided with a plurality of locking plates for insertion of the lamp seat.

4. The keyboard in accordance with claim 1, wherein each of the openings of the transparent panel has an inside formed with a plurality of corners having different angles.

5. The keyboard in accordance with claim 4, wherein when each of the indication lamps emit light beams in the respective opening of the transparent panel, the light beams emitted from each of the indication lamps have different angles by refraction of the corners of the respective opening of the transparent panel.

6. The keyboard in accordance with claim 1, wherein the main body has a periphery formed with a plurality of locking holes, and the transparent panel has a periphery formed with a plurality of locking bosses each snapped into and detachably locked in a respective one of the locking holes of the main body.

7. The keyboard in accordance with claim 1, wherein the lamp seat is provided with a switch to control operation of the indication lamps.
